(19) United States
(12) Patent Application Publication
(10) Pub. No.: US 2023/0315811 A1
(43) Pub. Date: Oct. 5, 2023

(54) BIAS REDUCING MACHINE LEARNING CORRECTION ENGINE FOR A MACHINE LEARNING SYSTEM

(71) Applicant: MICROSOFT TECHNOLOGY LICENSING, LLC, Redmond, WA (US)

(72) Inventors: Xiaoyu CHAI, Bellevue, WA (US); Gregory Lawrence BRAKE, Sammamish, WA (US); Siddharth R. PATIL, Issaquah, WA (US); Frederick D. CAMPBELL, Lynnwood, WA (US); Brandon Holmes PADDOCK, Seattle, WA (US); Ebru SENGUL, Kirkland, WA (US); Ajay CHETRY, Redmond, WA (US); Catherine Michelle BILLINGS, Bellevue, WA (US); Mateus CÂNDIDO LIMA DE CASTRO, Vancouver (CA); Austin J. MAK, Seattle, WA (US); Jonathon L. MORRIS, Bothell, WA (US); Cindy Liao HARTWIG, Seattle, WA (US); Tomas Aleksas MERECKIS, Bellevue, WA (US); Jilong LIAO, Issaquah, WA (US)

(21) Appl. No.: 17/708,346

(22) Filed: Mar. 30, 2022

(51) Int. Cl. G06K 9/62

(52) U.S. Cl. CPC G06K 9/6257; G06K 9/6265

(57) ABSTRACT

Provided are methods, systems, and computer-storage media for developing machine learning technology that is less susceptible to bias problems. A machine learning model may be developed with reduced error attributed to one or more sensitive features by utilizing a loss adjustment weight to determine an adjusted loss function used to train the model. The loss adjustment weight may be determined based on a count of a feature-label combination of a sensitive feature. The adjusted loss function is determined and configured to use the loss adjustment weight when determining loss during model training, and the output of the adjusted loss function is an adjusted loss. The machine learning model may be trained until the adjusted loss satisfies a loss threshold, indicative of an acceptable level of model inaccuracy. Accordingly, present embodiments can provide use case specific tailoring to improve machine learning systems by removing biases associated with certain data features.

### BACKGROUND

Computer-implemented technologies can assist users in developing and employing computing applications that utilize machine learning. These machine learning computing applications are typically implemented with one or more machine learning models. A model-development system can be part of or utilized for the machine learning computing system, for instance, in order to create, train, configure, or otherwise develop a machine learning model.

Machine learning models produced using conventional model-development systems are prone to producing models that reinforce biases existing in the training data used for training or developing the model. For example, these deficient models produce biased scores that can be inaccurate and/or that can reinforce unfair discriminations that exists in our societies. Conventional model-development technologies do not have functionality to address or counteract such biases that may be present in the data and thus prevent deficient models from being produced and deployed. Moreover, reducing these biases in a computationally efficient manner is a task that is difficult to implement in practice given the limitless number of unique datasets, ways that data can be partitioned into groups, and the various ways that data may contain biases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technologies described in this disclosure are directed toward computerized systems and methods for providing bias-reducing machine learning correction technology for machine learning systems. In particular, the described technologies involve a loss adjustment operation, or mechanism for performing the operation, that can be performed during the development of a trained machine learning model. The loss adjustment operation can comprise an application of one or more loss adjustment weights applied to a loss function used for training the machine learning model. Embodiments of the present disclosure may include determining loss adjustment weights based on a count of a feature-label combination in the dataset. For instance, in one embodiment, an adjustment weight is based on a count of the number of instances in the data where the same feature-label combination is present in the dataset. These features may comprise particular data features, such as sensitive features, which may be more likely to have bias. The loss adjustment weights may be computed based on a comparison of a predicted output and a ground truth or label. For example, the loss adjustment weights may be computed based on a suitable statistical analysis technique, such as chi-squared test, Fisher's exact test, and the like. After the loss adjustment weight has been computed, a custom loss function which consumes the loss adjustment weight (referred to going forward as the adjusted loss function) is used for training the machine learning model. In some instances, the adjusted loss function is a loss function that corresponds to the machine learning model, but that is modified based on the loss adjustment weight.

During model training, the output of the adjusted loss function, which is the adjusted loss, may be evaluated against a loss threshold to determine whether the model is sufficiently trained. In some embodiments, a model may be considered sufficiently trained when the adjusted loss is below the loss threshold or otherwise satisfies the loss threshold, indicating an acceptable level of inaccuracy (for example, the adjusted loss is below a threshold for inaccuracy or within a permitted range of accuracy). Once the machine learning model is determined to be sufficiently trained, the model may be deployed or otherwise made available for use in a computing application or service. For example, the machine learning model may be deployed to an operating system layer of a client device or server device. On the other hand, in response to the adjusted loss not satisfying the loss threshold value, the adjusted loss may be used to update the model parameters and retrain or further train the machine learning model.

In this manner, present embodiments provide technology to improve machine learning systems by removing or reducing biases associated with some features by performing a loss adjustment operation that utilizes a modified or customized loss function during the training of the machine learning model. Additionally and advantageously, embodiments of these technologies can remove biases in machine learning applications without requiring computer code for addressing the biases to run on the computing system where the model is deployed and/or running, such as a computer program operating on a client computer. Further, some embodiments may be personalized or tailored for certain types of data, such as sensitive data. Whereas existing approaches fail to allow personalization and/or require computationally expensive manipulation of large data sets, the embodiments disclosed herein can remove bias in a computationally efficient manner. These embodiments also can provide for the selection of sensitive features and can perform less computationally complex calculations to determine a loss adjustment weight that can be utilized to determine an adjusted loss function. Accordingly, present embodiments are not only more accurate, but also are more easily scaled compared to existing computationally intensive approaches.

### BRIEF DESCRIPTION OF THE DRAWINGS

The technology described herein is described in detail below with reference to the attached drawing figures, wherein:

FIG. 1 is a block diagram of an exemplary computing environment suitable for use in implementing some embodiments of this disclosure;

FIG. 2 is a block diagram illustrating an example distributed system in which some embodiments of this disclosure are employed;

FIG. 3 is a flow diagram of an example process for adjusting a loss function to reduce bias associated with a sensitive feature, in which some embodiments of this disclosure are employed;

FIG. 4 is a block diagram illustrating an example system in which some embodiments of this disclosure are employed;

FIG. 5 is a screenshot of an example graphical user interface (GUI) designed to receive one or more user inputs indicative of a selection or specification of a sensitive feature, a label, and a model type, according to some embodiments of this disclosure;

FIG. 6 is a flow diagram of an example process for applying one or more loss adjustment weights to train a machine learning model, according to some embodiments of this disclosure;

FIG. 7 is a flow diagram of an example process for deploying an adjusted machine learning model, according to some embodiments of this disclosure;

FIG. 8A depicts results of an example embodiment of the present disclosure reduced to practice, including a box-and-whisker plot indicating an improvement over the conventional technologies that fail to reduce bias associated with client devices of different age;

FIG. 8B depicts results of an example embodiment of the present disclosure reduced to practice, including a box-and-whisker plot indicating an improvement over the conventional technologies that fail to reduce bias associated with user ages;

FIG. 8C depicts results of an example embodiment of the present disclosure reduced to practice, including a box-and-whisker plot indicating an improvement over the conventional technologies that fail to reduce bias associated with user gender;

FIG. 8D depicts results of an example embodiment of the present disclosure reduced to practice, including a box-and-whisker plot indicating an improvement over the conventional technologies that fail to reduce bias associated with a price or quality of a client device;

FIG. 8E depicts results of an example embodiment of the present disclosure reduced to practice, including a box-and-whisker plot indicating an improvement over the conventional technologies that fail to reduce bias associated with client devices operating in different regions of the world;

FIG. 8F depicts a box-and-whisker plot of response rates for client devices operating in different regions of the world before the bias associated with client devices operating in different regions of the world had been removed in the example embodiment of FIG. 8E;

FIG. 9 is a block diagram of a computing device for which embodiments of this disclosure are employed; and

FIG. 10 is a block diagram of a computing environment in which embodiments of the present disclosure may be employed.

### DETAILED DESCRIPTION OF THE INVENTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be implemented within a standalone application, a service or hosted service (standalone or in combination with another hosted service), or a plug-in to another product, to name a few.

As access to complex computer technologies continues to increase, an increased number of users, such as developers, are looking toward machine learning technologies to improve predictive and classification functionality—all in an effort to improve operations and utilization of computer technologies. Computer technologies are challenged to adapt to the diverse needs and preferences of the increasing number of users. Conventionally, machine learning model-development systems are not configured with a computing infrastructure or logic to deliver unbiased predictions or machine learning outputs. In particular, conventional model-development systems may suffer from different data biases, which can lead to the machine learning models generated by these systems to be biased and/or inaccurate. Consequently, these deficient machine learning models can have disparate impact on users by affecting users differently based on user sensitivity to certain features. Additionally, bias can result in decreased accuracy of software applications employing the machine learning model, limiting their use to only certain types of data, and other problems.

One example of the type of biases introduced during model training is client-specific biases; this is when a model produces inaccurate scores for a group of users that was either underrepresented or not present in the data used to train & test the model. Conventional machine learning systems do not have a way to counteract such biases in their data and prevent the biases from resulting in client-specific biases in the produced models. Moreover, reducing client-specific biases in a computationally efficient manner is a task that is difficult to implement in practice given the limitless number of unique datasets, ways that data be partitioned into groups, and ways that data may contain biases.

Existing approaches to the bias problems include employing certain bias-removing algorithms, such as disparate impact remover and equality of odds. But such approaches can (1) require extensive computations making these existing approaches difficult to scale across any number of client devices operating in any number of operating environments, (2) require large storage space to store complex training data, (3) lack user-personalization or otherwise not permit those facilitating training the model to identify or modify certain data such as sensitive data, and/or (4) require extensive computational resources to be employed on system where the model is used, such as the client-side, and in some instances, on the system where the model is developed, such as the server-side, as well. This can result in placing a computational burden on the computing machine running the model, which often has limited computational resources, such as an internet of things (IoT) device or client device, and that may be looking to offload computations. Accordingly, there is a need to improve machine learning methodologies to be computationally efficient as well as scalable and generalizable across different systems where the model is deployed and used.

With the foregoing in mind, embodiments of the present disclosure are directed to providing bias reducing machine learning correction technology for model-development systems. In particular, a loss adjustment operation is performed during the development of a machine-learning model. Performing the loss adjustment operation can comprise applying one or more loss adjustment weights to a loss function used for training the machine-learning model. As used herein, “loss adjustment weight” comprises a value or degree to which an aspect of a loss function is modified to change a weight of loss (or error) attributed to a particular sensitive data feature (or groups of sensitive features). In some embodiments, a loss adjustment weight comprises a coefficient, scalar, multiplier, or another function applied to the training algorithm's default loss function. For instance, one example of a loss adjustment weight can include a value that is applied to the loss function (for example, multiplied, added, or used to re-calculate the output of the loss function) to modify the relative weight attributed to a group of the sensitive feature relative to other groups. As further described herein, a loss adjustment weight can be determined based on a count of a feature-label combination of a sensitive feature. As used herein, “a loss function,” which may also be referenced as “a cost function” or “an error function,” refers to a function that maps a value of one or more variables onto a real number indicative of some “loss” associated with the event or values. Example loss functions can include a computationally simple operation such as a subtraction, addition, absolute-value difference operation, or a more complex calculation. A loss function may be used to compute a difference between an estimated or predicted value and the true value, such that a difference of less magnitude is indicative of the estimate value being a more accurate representation of the true value. In this manner, the loss function can be used to assess the accuracy of an estimate value (for example, a prediction or classification output of a machine-learning model) relative to a true value. In this way, a loss function may be used during training of a machine learning model to determine whether the model has been sufficiently trained.

As used herein, “sensitive feature” may refer to an individual, measurable property or characteristic of a phenomenon (for example, a data feature) that may be subject to bias. Example sensitive features may include gender, age, race, native language, geographic location, type of client device, and the like. To facilitate discussion, sensitive features are discussed as having one or more “groups.” Using gender as an example, “gender” may refer to the “sensitive feature;” and “male,” “female,” and “non-binary” may refer to three example “groups” associated with the corresponding sensitive feature (i.e., gender).

Some embodiments of the present disclosure include determining one or more loss adjustment weights based on a count of a feature-label combination of sensitive features. As used herein, “a feature-label combination” refers to one or the combinations of a feature group and a label value. As used here, “label” is a representation of the “ground truth” and refers to known truth values, as opposed to mere estimates.

Additionally, the label may refer to training data whose identity or values are known. As discussed in more detail herein, the loss adjustment weights may be computed based on an appropriate statistical analysis methodology, such as chi-squared test, Fisher's exact test, or any other suitable statistical analysis methodology. Alternatively or additionally, the loss adjustment weights may be determined based on a comparison of a model output (such as a prediction output by the model) and the label (such as the ground truth). To facilitate computations, in some embodiments, training data used to train the machine learning model may be converted into tabular format. After a loss adjustment weight has been computed, a loss function used for training the machine learning model can be modified (or replaced), based on the loss adjustment weight, to generate an adjusted loss function, as discussed herein. As used herein, the output of the adjusted loss function may be referred to as the “adjusted loss.” The adjusted loss may be indicative of an accuracy of the predicted output of the machine learning model relative to the label (for example, ground truth). During training of a machine learning model, the adjusted loss may be evaluated against a loss threshold to determine whether the model is sufficiently trained. In response to the adjusted loss satisfying a loss threshold value indicative of an acceptable level of inaccuracy (for example, the adjusted loss is below a threshold for inaccuracy or within a permitted range of accuracy), the machine learning model is determined to be sufficiently trained, such that the adjusted machine learning model and the corresponding model parameters used to train the adjusted machine learning model may be deployed or otherwise made available for use in a computing application or service. Alternatively, in response to the adjusted loss not satisfying the loss threshold value, then the adjusted loss may be used to update the model parameters and retrain or further train the machine learning model. Thus, bias associated with a particular sensitive feature may be removed or reduced by, for example, determining a count of feature-label combination(s) of the sensitive feature and determining a loss adjustment weight (based on the count) used to adjust a loss function until the adjusted loss satisfies (for example, is below) the loss threshold value. In this manner, present embodiments provide a technology to improve machine learning systems by removing biases (for example, of sensitive features selected by a user) by modifying a loss function or providing a customized loss function, and may be personalized or customized to particular sensitive features. Whereas existing approaches may fail to allow user personalization and/or may require computationally expensive manipulation of large data sets that can pose a burden on server-side and client-side components, the present embodiments remove bias in a computational efficient manner, as described herein.

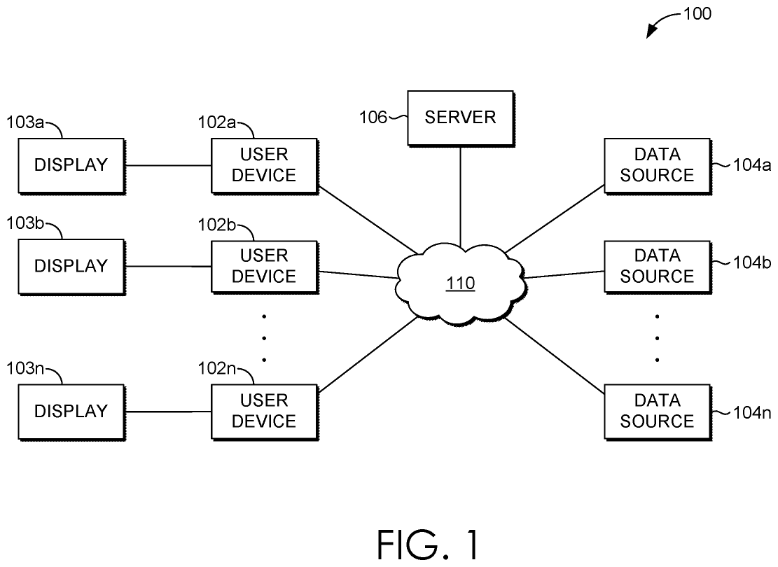

Turning now to FIG. 1, a block diagram is provided showing an example operating environment 100 in which some embodiments of the present disclosure may be employed. It should be understood that this and other arrangements described herein are set forth only as examples. Other arrangements and elements (for example, machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor or processing circuitry executing instructions stored in memory.

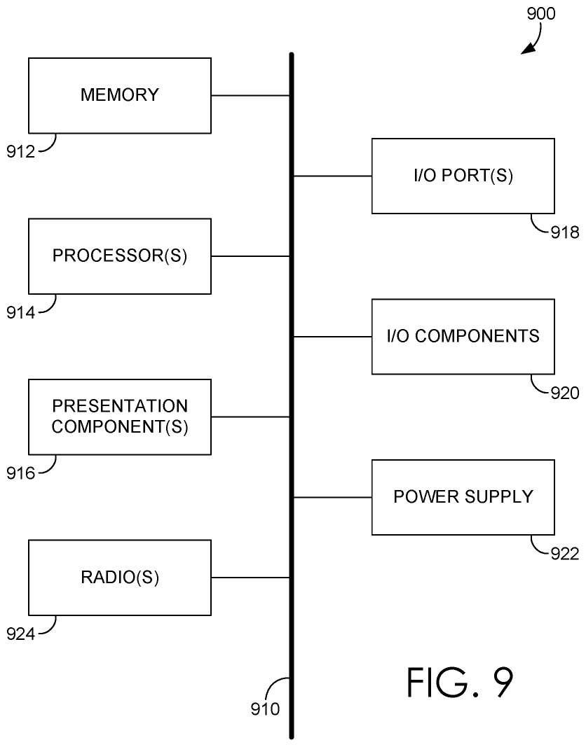

Among other components not shown, example operating environment 100 includes a number of user devices, such as user devices 102a and 102b through 102n; a number of data sources, such as data sources 104a and 104b through 104n; server 106; displays 103a and 103b through 103n; and network 110. It should be understood that environment 100 shown in FIG. 1 is an example of one suitable operating environment. Each of the components shown in FIG. 1 may be implemented via any type of computing device, such as computing device 900 described in connection to FIG. 9, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks employing any suitable communication protocol.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

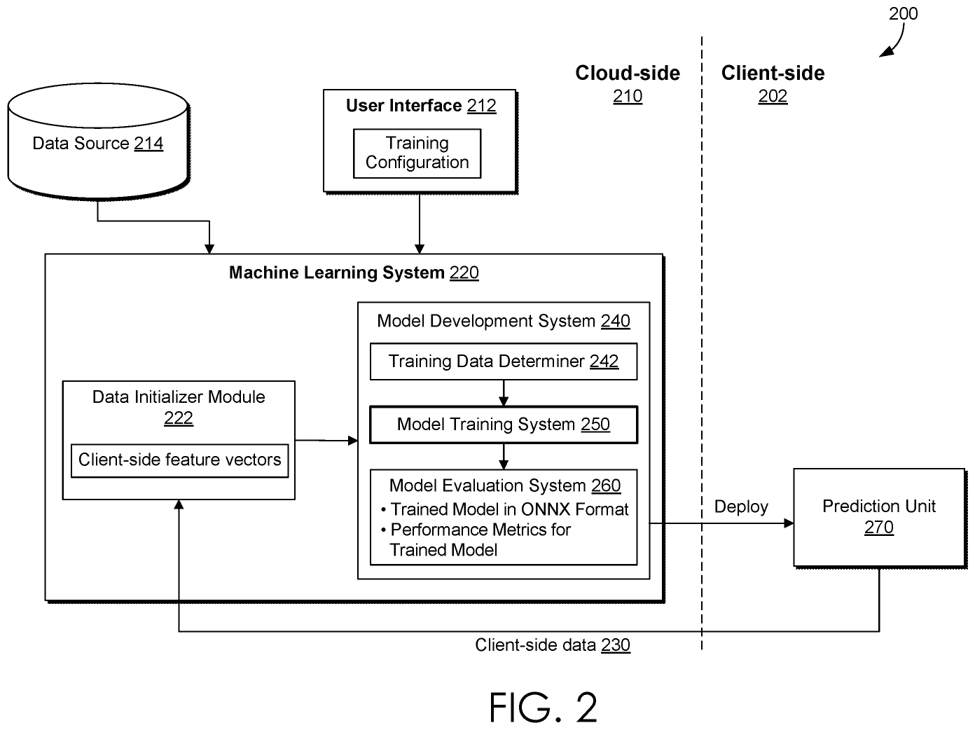

User devices 102a and 102b through 102n can be client devices on the client-side of operating environment 100, while server 106 can be on the server-side of operating environment 100. In more detail, FIG. 2 provides an example of computer infrastructure and logic on the server-side or the client-side. Server 106 can comprise server-side software designed to work in conjunction with client-side software on user devices 102a and 102b through 102n to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities. The displays 103a and 103b through 103n may be integrated into the user devices 102a and 102b through 102n. In one embodiment, the displays 103a and 103b through 103n are touchscreen displays.

User devices 102a and 102b through 102n may comprise any type of computing device capable of use by a user. For example, in one embodiment, user devices 102a through 102n may be the type of computing device 900 described in relation to FIG. 9. By way of example and not limitation, a user device may be embodied as a personal computer (PC), a laptop computer, a mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, or any combination of these delineated devices, or any other suitable computer device.

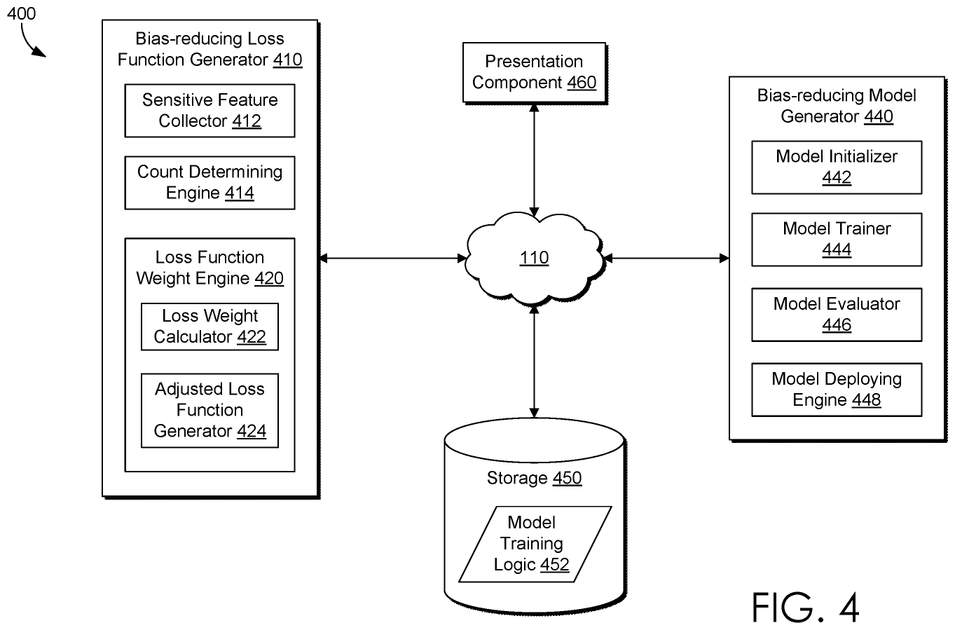

Data sources 104a and 104b through 104n may comprise data sources and/or data systems, which are configured to make data available to any of the various constituents of operating environment 100, or system 400 described in connection to FIG. 4. (For instance, in one embodiment, one or more data sources 104a through 104n provide (or make available for accessing) the adjusted machine learning model deployed by the model deploying engine 448 of FIG. 4.) Data sources 104a and 104b through 104n may be discrete from user devices 102a and 102b through 102n and server 106. Alternatively, the data sources 104b through 104n may be incorporated and/or integrated into at least one of those components. In one embodiment, one or more of data sources 104a through 104n may be integrated into, associated with, and/or accessible to one or more of the user device(s) 102a, 102b, or 102n or server 106. Examples of computations performed by sever 106 or user devices 102, and/or corresponding data made available by data sources 104a through 104n are described further in connection to system 400 of FIG. 4.

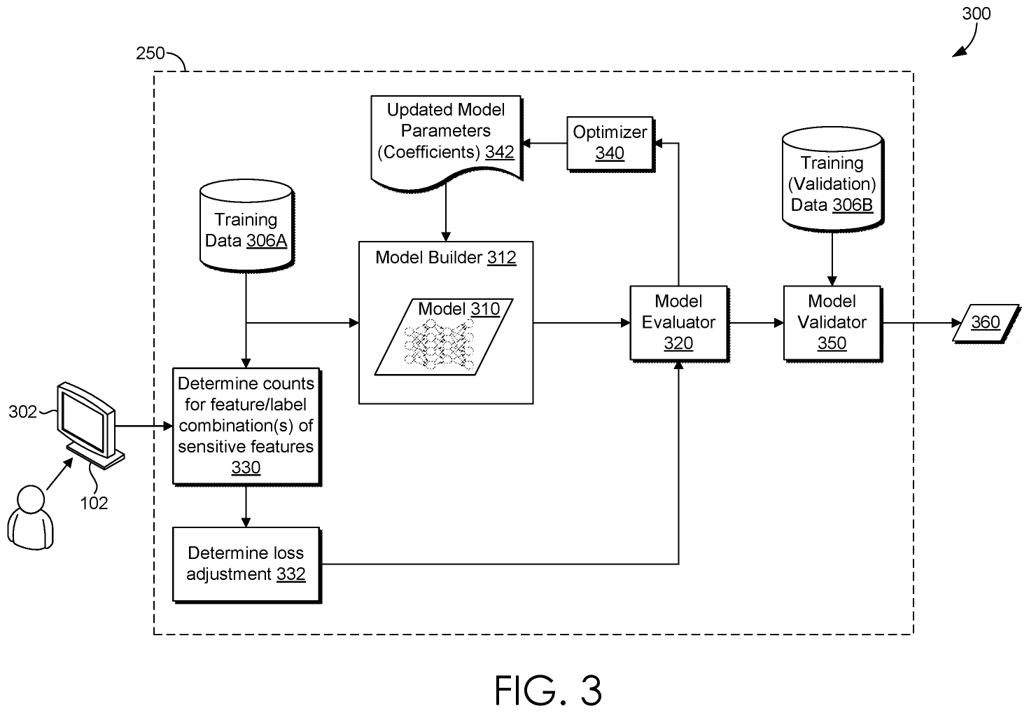

Operating environment 100 can be utilized to implement one or more of the components of systems 200 and 400, described in FIGS. 2 and 4, respectively. Operating environment 100 also can be utilized for implementing aspects of process flows 300, 600, and 700 described in FIGS. 3, 6, and 7, respectively. Referring now to FIG. 2, provided is a block diagram showing aspects of an example distributed system for implementing an embodiment of the disclosure and designated generally as system 200. System 200 represents only one example of a suitable computing environment. Other arrangements and elements can be used in addition to or instead of those shown, and some elements may be omitted altogether for the sake of clarity. Further, as with operating environment 100, certain elements described herein are functional entities that may be implemented as discrete or distributed components or in conjunction with other components, and in any suitable combination and location.

Example system 200 includes a client-side 202 and a server-side 210. In certain embodiments, the server-side 210 includes a user interface (UI) 212, a data source 214 and a machine learning system 220. As discussed below, the model may be trained on the server-side 210. Embodiments of UI 212 may be configured to invoke or access aspects of the machine learning system by way of a set of REST APIs, a python SDK, and the like. UI 212 can utilize a set of commands from users (for example, on the client-side 202) to integrate assigned services and computational resources. For example, the UI 212 may provide commands for deploying web-based applications, creating a postgres structured query langue (SQL) database, managing virtual machines, connecting software applications with user-specific storage devices, and so forth. In the context of machine learning, the UI 212 implements commands for scheduling jobs that train machine learning models, retrain machine learning models, and use the trained machine learning model for inference. As such, some embodiments of UI 212 use data transformation and training configurations received from users as inputs to the underlying actions that are executed. In some embodiments, UI 212 comprises a command line interface (CLI) or a graphical user interface (GUI).

The machine learning system 220 includes a data initializer module configured to receive client-side data 230. In some embodiments, the data initializer module 222 pre-processes the client-side data to generate feature vectors. For example, a client-side device (such as, user device 102 of FIG. 1) may receive user inputs indicative of the sensitive features, which are communicated to the machine learning system 220 by way of the data initializer module 222. It should be understood that input for the generation of feature vectors by the data initializer module 222 is not limited to client-side data 230, but may be based on any suitable data (for example, from server-side 210 or client-side 202).

The machine learning system 220 includes a model-development system 240 configured to train and format the machine learning model before deploying the trained machine learning model. The model-development system 240 may include a training data determiner 242, a model training system 250, and a model evaluation system 260. The training data determiner 242 may be configured to receive the training data from the training data determiner 224 and/or the initialized data from the data initializer module 222 to parsimoniously describe the data. The training data determiner 242 may define parameters for selecting metadata (for example, a description model) used to describe the data. In one embodiment, the training data determiner 242 describes the data based on a model that would result in the shortest permissible description of the data. In this manner, the computational resources utilized to store the data may be reduced.

In some embodiments, the training data determiner 242 is configured to process the feature vectors to determine suitable training data to be used by a model-development system 240. In some embodiments, the training data determiner 242 is configured to track and store any suitable data which may be used to train a machine learning model. For example, the training data determiner 242 may track user interactions with a software application, determine data (for example, custom data) received by a user, receive ground truths or labels to be used to evaluate (block 320 of FIG. 3) or validate (block 350 of FIG. 3) the machine learning model.

In some embodiments, the training data determiner 242 is configured to query the data source 214 storing the label data, for example, from the client-side 202. It should be understood that the data retrieved training data determiner 242 is not limited to client-side data 230, but may be based on any suitable data (for example, from cloud-side 210 or client-side 202).

The model training system 250 is configured to train a machine learning model. As described herein, the model training system 250 may include the logic (such as the model training logic 252 of FIG. 4) configured to produce the loss adjustment weights. Additionally or alternatively, the model training system may be configured to determine and apply loss adjustment weights to a loss function to reduce bias attributed to certain groups of sensitive features. A more detailed discussion of aspects of the model training system 250 is provided below with respect to FIGS. 3-7. In some embodiments, the model training system 250 trains the machine learning model until the adjusted loss is below the loss threshold value indicative of an acceptable error margin (for example, level of inaccuracy).

The model evaluation system 260 is configured to evaluate (for example, via model evaluator 320 of FIG. 3) and/or validate (for example, via model validator 350 of FIG. 3) a machine learning model trained by the model training system 250, as discussed with respect to the model evaluator 446 of FIG. 4. For example, the model evaluation system 260 assesses the performance of the machine learning model and its outputs relative to training data and/or thresholds, as discussed in more detail below with respect to FIGS. 3-7. After evaluating and validating the machine learning model, the model evaluation system 260 may prepare the machine learning model for deployment. In some embodiments, the model evaluation system 260 is configured to format the machine learning model based on the training data applied to the model, the training methodology employed by the model training system 250, and any additional or alternatively formatting-specific parameters. The format of the machine learning model may define a structure and encoding of the data stored in the structure. In one embodiment, the machine learning model may be represented by an ONNX format, which defines a common set of operations that are integratable across machine learning models.

Although the model development system 240 is discussed as including specific components, it should be understood that the model development system 240 any other or additional components. For example, the model development system 240 may include a user interface, a data query module, a data preparation and transformation module, and a module to produce a file containing a serialized version of the machine learning model (such as an .onnx file), to name a few.

Thereafter, the trained machine learning model may be deployed to a prediction unit 270 (for example, user device 102). In some embodiments, the machine learning model may be integrated into the operating system of the user device 102. Alternatively or additionally, the machine learning model may be deployed via or to any suitable abstraction layer(s) such as the application layer, hardware layer, and so forth, of the prediction unit 270.

Turning to FIG. 3, depicted is an example flow diagram of a process 300 for adjusting a loss function to reduce bias associated with a sensitive feature, according to some embodiments of this disclosure. Other arrangements and elements can be used in addition to or instead of those shown, and some elements may be omitted altogether for the sake of clarity. Further, as with operating environment 100, certain elements described herein are functional entities that may be implemented as discrete or distributed components or in conjunction with other components, and in any suitable combination and location. In some embodiments, the process 300 may be implemented by the server 106 of FIG. 1, the user devices 102 of FIG. 1, or the machine learning system 220 of FIG. 2. In one embodiment, aspects of process 300 may be performed by the model training system 250 of FIG. 2.

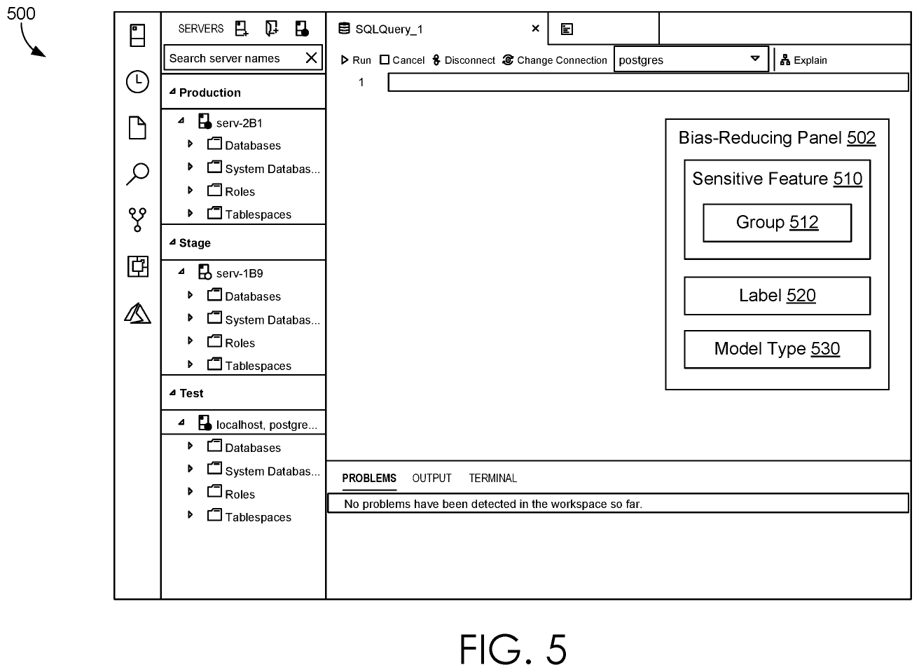

With this in mind, the process 300 may include receiving a user input by way of a graphical user interface (GUI) 302 of the user device 102. The graphical user interface 302 may receive any suitable input, such as a request for preparing training data to train a model or a request indicative of machine learning parameters, such as the sensitive features, corresponding groups, an indication of a type of machine learning model to be used, training data, and the like. For example, the GUI 302 may include a JavaScript Object Notation (JSON) file configured to receive user inputs. The user inputs may include a selection of the sensitive features. Due to the language-independent structure of a JSON file, the JSON file may be employed by processing circuitry employing any suitable machine learning model using any suitable programming language. Nevertheless, it should be understood that the GUI 302 may include any suitable screen regions, selectable icons, toggles, and controls, for example, to select sensitive features and groups. One example of the GUI 302 may be found in FIG. 5.

The process 300 includes receiving training data, as discussed below with respect to the sensitive feature collector 412. In some embodiments, the training data may include or be divided into training data 306A used for model training and training validation data 306B used for model validation. The training data 306A may include a labeled data for use to train the machine learning model 310 by the model builder 312. “Labeled data” may refer to data that has been collected and joined with their corresponding labels. Thus the machine learning model builder 312 may receive and use the labeled training data 306A for training purposes. In one embodiment, as a machine learning model 310 is being trained using the training data 306A or once the machine learning model 310 has been trained using training data 306A the machine learning model 310 may be evaluated (block 320), as discussed with respect to the model evaluator 446 of FIG. 4. After or as part of the evaluation (block 320) of the trained machine learning model 310, the machine learning model 310 may be validated by inputting the training validation data 306B to the machine learning model 310 to determine an output such as a categorization output or a prediction output. It should be understood that in some embodiments the model evaluator 320 and the model validator 350 may be combined or either the model evaluator 320 or the model validator 350 may be omitted.

In some embodiments, training data 306A used by the model builder 312 to train the machine learning model 310 may be converted into a vector or tabular format that may include or be associated with an indication of a label. The vector or tabular format may facilitate computations, such as determining (block 330) a count of feature/label combinations for sensitive features, as discussed below with respect to the count determining engine 414 of FIG. 4. However, it should be understood that determining the count of the feature-label combinations is not limited to calculations performed on data organized in a particular format or structure, since additional computations, such as vector calculus, linear arithmetic, and any other suitable computations, may be performed on any suitable formatted training data. In one embodiment, the sensitive features are user-specified (for example, via the GUI 302) and the counts are determined (block 330) based on a prevalence or frequency of each group of the sensitive feature(s) relative to the label. A detailed discussion of embodiments for determining (block 330) the counts for feature/label combinations of sensitive features is discussed below with respect to the count determining engine 414 of FIG. 4.

In addition, the process 300 includes determining (block 332) loss adjustment weights, as discussed below with respect to the loss weight calculator 422 of FIG. 4. The loss adjustment weights may be determined based on any suitable statistical analysis methodology, such as chi-squared test, Fisher's exact test, and the like. The loss adjustment weights may be applied to the loss function employed as part of evaluating (block 320) the machine learning model 310. In this example, evaluation 320 includes comparing the output of the adjusted loss function against a threshold (as discussed below with respect to the model training logic 452 of FIG. 4).

Evaluation (block 320) of the machine learning model 310 may be based on the output predicted (or otherwise determined) by the machine learning model 310, the label (for example, ground truth) corresponding to training data 306A, and the loss adjustment weights, as discussed below with respect to the model training logic 452 of FIG. 4. In one embodiment, the model training logic 452 defines a loss function corresponding to a specific type of machine learning model 310. Evaluation (block 320) of the machine learning model 310 may include computing an adjusted loss by applying the loss adjustment weights to the loss function corresponding to the machine learning model 310. The output of the loss function (i.e., the adjusted loss) may be compared to a loss threshold value(s) indicative of an acceptable level of inaccuracy or error.

In response to the adjusted loss not being below the loss threshold value, the machine learning model 310 is retrained, as discussed below with respect to the bias-reducing model generating engine 440 of FIG. 4. Retraining the machine learning model 310 may include applying the adjusted loss to an optimizer 340. The type of optimizer 340 employed to retrain the machine learning model 310 may be based on the type of machine learning model 310. For example, in the context of a neural network machine learning model, example optimizers 340 include a gradient descent optimization algorithm, a parallelizing and distributing stochastic gradient descent (SGD) algorithm, and the like. The parameters of the machine learning model may be updated (block 342) based on the optimizer 340. In one embodiment, the machine learning parameters include the coefficients of the machine learning model 310, such that the optimizer 340 updates the coefficients. Example coefficients include any value assigned to a predictor (for example, input) variable and a response (for example, output) variable. By retraining the machine learning model 310 until the adjusted loss is below the loss threshold value, an accurate model that is not disproportionately skewed by a particular group of a sensitive feature may be achieved.

In response to the adjusted loss satisfying the loss threshold (for example, where the adjusted loss is below the loss threshold where the threshold corresponds to a maximum tolerated inaccuracy), the machine learning model 310 is determined to be sufficiently trained, such that the machine learning model 310 and the corresponding model parameters used to train the machine learning model 310 may proceed to being validated (block 350). Validating (block 350) the machine learning model 310 may include receiving training validation data 306B. As discussed above, the training validation data 306B is separate from the training data 306A. For example, the training validation data 306B may be used for validation purposes instead of model training purposes. In some embodiments, the machine learning model 310 may be validated (block 350) using the adjusted loss function. For example, the adjusted loss function may be used as the score function used to validate the model. If the machine learning model does not pass validation, then the machine learning model may be further trained and revised. On the other hand, if the machine learning model passes validation, the machine learning model may be deployed (block 360), for example, to the user device 102.

Turning to FIG. 4, depicted is a block diagram illustrating an example system 400 in which some embodiments of this disclosure are employed. System 400 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 400 includes network 110, which is described in connection to FIG. 1, and which communicatively couples components of system 400 including bias-reducing loss function engine 410 (which includes sensitive feature collector 412, count determining engine 414, loss function weight engine 420, loss weight calculator 422, and adjusted loss function generator 424), bias-reducing model generating engine 440 (which includes model initializer 442, model trainer 444, model evaluator 446, and model deploying engine 448), and storage 450 (which includes model training logic 452). The bias-reducing loss function engine 410 and the bias-reducing model generating engine 440 may be embodied as a set of compiled computer instructions or functions, program modules, computer software services, or an arrangement of processes carried out on one or more computer systems, such as computing device 900 described in connection to FIG. 9, for example.

In one embodiment, the functions performed by components of system 400 are associated with one or more applications, services, or routines. In one embodiment, certain applications, services, or routines may operate on one or more user devices (such as user device 102a, for example, on the client-side 202 of FIG. 2), servers (such as server 106, for example, on the server-side 210 of FIG. 2), may be distributed across one or more user devices and servers, or may be implemented in a cloud-based system. Moreover, in some embodiments, these components of system 400 may be distributed across a network, including one or more servers (such as server 106, for example, on the server-side 210) and client devices (such as user device 102a, for example, on the server-side 210 of FIG. 2), in the cloud, or may reside on a user device (such as user device 102a). Moreover, these components, functions performed by these components, or services carried out by these components may be implemented at appropriate abstraction layer(s) such as the operating system layer, application layer, hardware layer, and so forth, of the computing system(s). Alternatively, or in addition, the functionality of these components and/or the embodiments of the disclosure described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and so forth. Additionally, although functionality is described herein with reference to specific components shown in example system 200, it is contemplated that in some embodiments functionality of these components can be shared or distributed across other components.

Continuing with FIG. 4, the bias-reducing loss function engine 410 is generally responsible for calculating one or more loss adjustment weights and providing the one or more loss adjustment weights to a loss function used to evaluate a trained machine learning model (for example, the machine learning model 310 of FIG. 3 trained using optimizer 340 of FIG. 3). In this manner, the loss adjustments weights may reduce a bias attributed to a sensitive feature, or specific group of sensitive features, by removing the disproportionate weight attributed to the error associated with the sensitive feature. The sensitive feature collector 412 of the bias-reducing loss function engine 410 may be configured to determine sensitive features and corresponding groups. In some embodiments, the sensitive features and corresponding groups may be received via a user interaction with a GUI, as discussed below with respect to FIG. 5. For example, a GUI may receive a first user input indicative of a sensitive feature corresponding to “gender” and may receive a second user input indicative of the corresponding groups being “male” or “female”. In one embodiment, the first user input and/or the second user input is received via a JSON file. Alternatively or additionally, it should be understood that the sensitive features and corresponding groups may be determined based on feedback from a computer, such that determining sensitive features may not including receiving a user input, for example, in the context of unsupervised machine learning.

The count determining engine 414 is configured to determine features, such as the sensitive features described herein. In some embodiments, the features may be determined based on raw data. In some embodiments, the count determining engine 414 is configured to receive training data (for example, training data 306A of FIG. 3). The training data may be received as raw data or structured or processed data. The raw data may include any data (for example, source data) that has not been processed to remove anomalies or to uniformly structure, scale and/or store the data, for example. In one embodiment, the count determining engine 414 may be configured to execute queries against relational data structures (for example, of a data source 104 of FIG. 1) to receive raw data as query results. In another embodiment, the count determining engine 414 is configured to receive the raw data from users (for example, user device 102 of FIG. 1). For example, users may provide, via a GUI (for example, the GUI of FIG. 5), an input indicative of raw data selection or an input indicative of source from which to retrieve raw data.

Example training data includes any labeled data or unlabeled data. For example, training data may include computing device information (such as charging data, date/time, or other information derived from a computing device), user-activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events; other user interactions with a user device, and so forth) including user activity that occurs over more than one user device, user history, session logs, application data, contacts data, calendar and schedule data, notification data, social network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personalization-related (for example, “personal assistant” or “virtual assistant”) application or service), home-sensor data, appliance data, global positioning system (GPS) data, vehicle signal data, traffic data, weather data (including forecasts), wearable device data, other user device data (which may include device settings, profiles, network-related information (for example, network name or ID, domain information, workgroup information, other network connection data, Wi-Fi network data, or configuration data, data regarding the model number, firmware, or equipment, device pairings, such as where a user has a mobile phone paired with a Bluetooth headset, for example, or other network-related information)), gyroscope data, accelerometer data, payment or credit card usage data (which may include information from a user's PayPal account), purchase history data (such as information from a user's Xbox Live, Amazon.com or eBay account), other data that may be sensed or otherwise detected, data derived based on other data (for example, location data that can be derived from Wi-Fi, cellular network, or IP (internet protocol) address data), calendar items specified in user's electronic calendar, and nearly any other data that may be used to train a machine learning model, as described herein.

The count determining engine 414 is configured to determine (block 330 of FIG. 3) sensitive features, for example, from the raw data (for example, training data 306 of FIG. 3). The raw data may be retrieved from the storage 450. In some embodiments, sensitive features may be determined via any suitable engineering process, which may include at least one of the following steps: brainstorming or testing features, deciding which features to create, creating the features, testing the impact of the created features on a task or training data, and iteratively improving features. Sensitive features may be engineered or otherwise determined using any suitable computations, including, but not limited to, (1) numerical transformation (for example, taking fractions or scaling), (2) employing a category encoder to categorize data, (3) clustering techniques, (4) group aggregation values, (5) principal component analysis, and the like. In some embodiments, the count determining engine 414 may assign different levels of significance to the sensitive features, such that certain sensitive features that have a higher level of significance are weighted higher by the loss weight calculator 422. In this manner, the loss weight calculator 422 may prioritize and/or rank sensitive features or their corresponding groups.

The count determining engine 414 may convert raw data into any suitable format. By way of non-limiting example, the count determining engine 414 may convert raw data into a tabular format. Taking gender as an example of a binary outcome (although gender may not be binary, for purposes of simplifying this example, gender will be discussed as binary), the count determining engine 414 may receive training data (which may comrpise raw data) indicating whether a prediction was accurate (indicated as “Yes”) in Table 1 below or inaccurate (indicated as “No”) in Table 1. Example predictions include whether a camera accurately identified a person, whether a survey was completed as predicted, and any additional or alternative prediction. Taking completion of a survey as an example, a label of “Yes,” as shown in Table 1, indicates that the survey was completed by the corresponding gender; while a label of “No,” as shown in Table 1, indicates that the survey was not completed. Thus, for a label of “no” the prediction failed to satisfy a label.

TABLE 1
Raw data

| DEVICE ID | GENDER | LABEL |
|---|---|---|
| 1 | FEMALE | YES |
| 2 | MALE | NO |
| 3 | FEMALE | NO |
| . . . | . . . | . . . |

TABLE 2
Tabular format of raw data

| COUNT | LABEL YES | LABEL NO | TOTAL |
|---|---|---|---|
| FEMALE | 2 | 3 | 5 |
| MALE | 4 | 1 | 5 |
| TOTAL | 6 | 4 | 10 |

The count determining engine 414 may convert the labeled raw data of Table 1 into the tabular format of Table 2. As depicted, taking gender as a sensitive feature, the gender is divided into two groups, namely, female and male, which are shown as rows in the table. For each group (for example, row), the label may be determined by adding up the times the ground truth was satisfied (for example, the “Yes” from the third column of Table 1) and adding up the times the ground truth was not satisfied (for example, the “No” from the third column of Table 2). As illustrated in Table 2, the labels may be divided into the times the ground truth was satisfied (for example, the “Label Yes” column Table 2) and the times the ground truth was not satisfied (for example, the “Label No” column of Table 2). The rows and the columns may be added to calculate the totals corresponding to a respective column and/or row. In this example, the count for the feature-label combination of sensitive features, such as gender, may be determined and organized as shown in Table 2. In particular, the counts for the female-yes combination, the male-yes combination, the female-no combination, the male-no combination, and their corresponding summations, may be retrieved from Table 2 to calculate the loss adjustment weights. The Table 1 and the Table 2 may be stored in storage 450.

Although this example is discussed in the context of binary groups of a sensitive feature, it should be understood that these embodiments may be employed by a non-binary groups of sensitive features, such as race, nationality, sexual orientation, age, other groupings, and so forth. Additionally, any number of sensitive features can be engineered by the count determining engine 414. In some embodiments, the count determining engine 414 may determine a count of feature-label combinations across more than one feature. For example, the count determining engine 414 may determine count of feature-label combinations across gender, age, and ethnicity for any groups of each of these three features. Accordingly, embodiments of the present disclosure are not limited to determining a count of feature-label combinations across only one feature (for example, gender). In either case, in one embodiment, the cross-tabular table generated by the count determining engine 414 may be an N×N table where the number of rows equals the number of columns, as in Table 2, which includes the same number of rows as columns. Moreover, although this example is discussed in the context of a Table, the embodiments discussed herein are not limited to data stored in tabular format. The computations described herein may be applied to any statistically independent set of variables, such as the feature and the label.

The model training logic 452 of the storage 450 may define a set of rules or conditions used to calculate or determine the loss adjustment weight, the loss function for a machine learning model, and the like. In some embodiments, the model training logic 452 may be used by the model training system 250 of FIG. 2 to train the machine learning model, to determine a loss function based on the type of model being trained, to determine the loss adjustment weights based on the count of feature-label combinations of sensitive features. The loss function employed may be based on the type of machine learning model. For example, a prediction model may employ any suitable regression loss function, such as a mean square error function, a mean absolute error function, a mean bias error function, and the like. As another example, a classification model may employ any suitable classification loss function, such as a hinge loss function (for example, multi-class support vector machine loss function), a cross entropy loss function, and the like. As such, the model training logic 452 may define the type of loss function used by the loss function weight engine 420 based on the type of model trained by the bias-reducing model generating engine 440.

Continuing with FIG. 4, the loss function weight engine 420 is configured to compute the loss adjustment weight used by the model evaluator 446 to evaluate (block 320 of FIG. 3) the machine learning model (for example, machine learning model 310 of FIG. 3) trained by the model trainer 444. Additionally, the loss function weight engine 420 may compute the adjusted loss, for example, by applying the loss adjustment weights to the loss function corresponding to the machine learning model, as determined by the model training logic 452.

The loss weight calculator 422 may receive the counts for feature-label combinations of a sensitive feature from the count determining engine 414. The loss weight calculator 422 may calculate the loss adjustment weights based on the counts for feature-label combinations. The loss weight calculator 422 may calculate the loss adjustment weights based on any suitable statistical method, such as the Chi-square test, Fisher's exact test, UniODA test, Mann-Whitney U test, Kruskal-Wallace Test, and the like.

Continuing on the gender example above, the loss weight calculator 422 may determine the loss adjustment weights by performing a chi-squared test. Using equation 1, WEIGHT IN EACH CELL=(ROW MARGINAL SUM*COLUMN MARGINAL SUM)/(GRAND SUM*CELL VALUE), the loss weight calculator 422 may determine the weight in each cell of Table 3. A more detailed illustration of the calculations is provided in Table 3.

TABLE 3
Loss adjustment weights calculation.

| WEIGHT | LABEL YES | LABEL NO |
|---|---|---|
| FEMALE | 5 * 6/(10 * 2) = 1.5 | 5 * 4/(10 * 3) = 0.67 |
| MALE | 5 * 6/(10 * 4) = 0.75 | 5 * 4/(10 * 1) = 2 |

As depicted in Table 3 and using the data in Table 2, the weights in each of the cells of Table 3 may be calculated in accordance with equation 1, whereby the sum of a row (of Table 2) is multiplied by the sum of the column (of Table 2), and then divided by the product of (1) the sum of all entries (for example, bottom right value in Table 2) and (2) the value (for example, from Table 2) of that corresponding cell.

The loss weight calculator 422 may store the calculated loss adjustment weights in storage 450. In some embodiments, the loss adjustment weights may be stored in a hash table to facilitate associating the loss adjustment weights to any data type. For example, the loss weight calculator 422 may assign the loss adjustment weights to certain training data, such that the hash table associates the loss adjustment weights to training data that is used to evaluate the machine learning model by the model evaluator 446.

TABLE 5

| Table 4. Loss adjustment weights | | | | Table 5. Hash table | | | |
|---|---|---|---|---|---|---|---|
| GENDER | LABEL | WEIGHT | | DEVICE ID | GENDER | LABEL | WEIGHT |
| FEMALE | YES | 1.5 | → | 1 | FEMALE | YES | 1.5 |
| FEMALE | NO | 0.67 | | 2 | MALE | NO | 2 |
| MALE | YES | 0.75 | | 3 | FEMALE | NO | 0.67 |
| MALE | NO | 2 | | . . . | . . . | . . . | |

Table 4 shows example computed loss adjustment weights. As depicted in Table 5, a loss adjustment weight may be assigned to a user device (for example, denoted in Table 5, as “DeviceID”). Although the illustrated Table 5 shows one weight assigned per user device, it should be understood that in certain embodiments, more than one weight may be assigned to a user device. For example, one weight may be assigned per feature for a plurality of features, or more than one weight may be assigned for one feature.

The adjusted loss function generator 424 may determine the adjusted loss. In some embodiments, the adjusted loss function generator 424 receives the loss adjustment weights, an output predicted by the machine learning model, and/or a label corresponding to training data. In response to receiving the aforementioned, the adjusted loss function generator 424 may determine the adjusted loss. The adjusted loss function generator 424 may adjust the loss function corresponding to the machine learning model based on the loss adjustment weights, such that the adjusted loss function is configured to remove bias associated with the sensitive feature determined by the sensitive feature collector 412. In some embodiments, the adjusted loss function generator 424 may adjust the loss function based on the loss adjustment weights and then the adjusted loss function is used to calculate the adjusted loss.

The bias-reducing model generating engine 440 may receive a machine learning model trained based on the bias-reducing loss function engine 410. The model initializer 442 may select and initialize a machine learning model. Example machine learning models include a neural network model, a logistic regression model, a support vector machine model, and the like. Initializing the machine learning model may also include causing the model initializer 442 to determine a loss function associated with the machine learning model. Initializing the machine learning model may include causing the model initializer 442 to determine model parameters and provide initial conditions for the model parameters. In one embodiment, the initial conditions for the model parameters may include a coefficient for the model parameter.

The model trainer 444 may train the machine learning model determined by the model initializer 442. As part of training the machine learning model, the model trainer 444 may receive outputs from the model initializer 442 to train the machine learning model. In some embodiments, the model trainer may receive the type of machine learning model, the loss function associated with the machine learning model, the parameters used to train the machine learning model, and the initial conditions for the model parameters. The model trainer 444 may iteratively train the machine learning model by using the optimizer 340 (of FIG. 3), such that training data is input into the machine learning model until certain conditions are met, for example, as determined by the model evaluator 446. In this case, the machine learning model may be trained with or without the loss function weight engine 420. Alternatively, the model trainer 444 may feed one set of training data to the machine learning model to generate a predicted output that is used by the model evaluator 446 to calculate the adjusted loss, as discussed above based on the loss function weight engine 420. For example, the model trainer 444 may train the machine learning model by applying the loss adjustment weights to the loss function.

The model evaluator 446 may evaluate the accuracy of the machine learning model trained by the model trainer 444. In some embodiments, the model evaluator 446 is configured to assess the accuracy of the model based on a loss (for example, error) determined based on the loss function. For example, the model evaluator 446 may receive an indication of the loss adjustment weights and determine an adjusted loss by applying the loss adjustment weights to the loss function corresponding to the machine learning model. The output of the loss function (i.e., the adjusted loss) may be compared to the loss threshold value(s) indicative of an acceptable level of inaccuracy or error. In response to the adjusted loss not being below the loss threshold value(s), the model trainer 444 may retrain the machine learning model. Alternatively, in response to the adjusted loss being below the loss threshold value(s), the machine learning model is determined to be sufficiently trained, such that the machine learning model and the corresponding model parameters used to train the machine learning model may be validated.

The model evaluator 446 may validate the machine learning model. In some embodiments, the model evaluator 446 may receive training data (for example, the training validation data 306B of FIG. 3) used for validation purposes instead of training purposes. In some embodiments, the training data used by the model evaluator 446 to validate the machine learning model may correspond to training data different from the training data used by the model trainer 444 to train the machine learning model. In some embodiments, the training data received via the bias-reducing model generating engine 440 may be split into training data used by the model trainer 444 and training data used by the model evaluator 446. In one embodiment, the training data used by the model evaluator 446 may be unlabeled, while the training data used by the model trainer 444 may be labeled. In some embodiments, the model evaluator 446 may evaluate the model using the adjusted loss function. In one embodiment, the adjusted loss function may be used as the score function used to validate the model.

The model evaluator 446 may validate the machine learning model based on a score function. The score function may facilitate determining probabilistic scores for a classification machine learning model or estimated averages for regression problems, to name a couple examples. It should be understood that the score function may include any suitable algorithm applied to training data (such as the training validation data 306B of FIG. 3) to uncover probabilistic insights indicative of the accuracy of the machine learning model. In some embodiments, the model evaluator 446 may employ a score function to determine whether the machine learning model is at or above a validation threshold value indicative of an acceptable model validation metric. The model validation metric may include a percent accuracy or fit associated with applying the machine learning model trained by the model trainer 444 to the training data. If the model evaluator 446 determines that the machine learning model fails to meet the model validation metric, then the model trainer 444 may continue to train the machine learning model. On the other hand, if the model evaluator 446 determines that the machine learning model passes validation, the model deploying engine 448 may deploy the machine learning model, for example, to the user device 102.

In some embodiments, the model deploying engine 448 may receive a machine learning model determined to be sufficiently trained. The model deploying engine 448 may deploy a trained machine learning model to any suitable abstraction layer. For example, the model deploying engine 448 may transmit the machine learning model to the operating system layer, application layer, hardware layer, and so forth, associated with a client device or client account. In the context of the model deploying engine 448 transmitting the machine learning model to the operating system layer (for example, of a client device), an end-to-end bias-reducing reducing machine learning system (for example, the machine learning model trained by the model-development system 240 of FIG. 2) may be deployed to computing devices. A user may engage with an interface (for example, GUI 500 of FIG. 5) to input a selection of sensitive features that are used to remove biases based on employing the deployed machine learning model, as discussed herein. In one embodiment, a client device may include the embodiments disclosed herein (for example, the bias-reducing loss function engine 410, the bias-reducing model generating engine 440, or any subcomponent) pre-installed on any suitable abstraction layer (for example, operating system layer). In this manner, a computing device may include out-of-the-box software that removes bias, as discussed herein. The model deploying engine 448 may be configured to generate a GUI and related content, for example, on the display 103a of the user device 102a of FIG. 1.

As shown, example system 400 includes a presentation component 460 that is generally responsible for presenting content and related information, such as the GUI of FIG. 5, to a user. Presentation component 460 may comprise one or more applications or services on a user device, across multiple user devices, or in the cloud. For example, in one embodiment, presentation component 460 manages the presentation of content to a user across multiple user devices associated with that user. In some embodiments, presentation component 460 may determine a format in which content is to be presented. In some embodiments, presentation component 460 generates user interface elements, as described herein. Such user interface elements can include queries, prompts, graphic buttons, sliders, menus, audio prompts, alerts, alarms, vibrations, pop-up windows, notification-bar or status-bar items, in-app notifications, or other similar features for interfacing with a user.

Turning to FIG. 5, illustrated is a screenshot of an example graphical user interface (GUI) 500 designed to receive, via a bias-reducing panel 502, one or more user inputs indicative of a selection or specification of a sensitive feature 510, a corresponding group 512, a label 520, and/or a model type 530, according to some embodiments of this disclosure. Although the illustrated example screenshot includes text boxes corresponding to each of the sensitive feature 510, the corresponding group 512, the label 520, and/or the model type 530, it should be understood that the GUI may receive an input indicative of a selection or specification of the sensitive feature 510, the corresponding group 512, the label 520, and/or a model type 530 via any additional or alternative mechanism, such as a drop-down window, a click-selection, a pop-up window, and the like. In one embodiment, the bias-reducing panel 502 may be a JSON file configured to receive user input(s) indicative of the sensitive feature 510, the corresponding group 512, the label 520, and/or a model type 530.

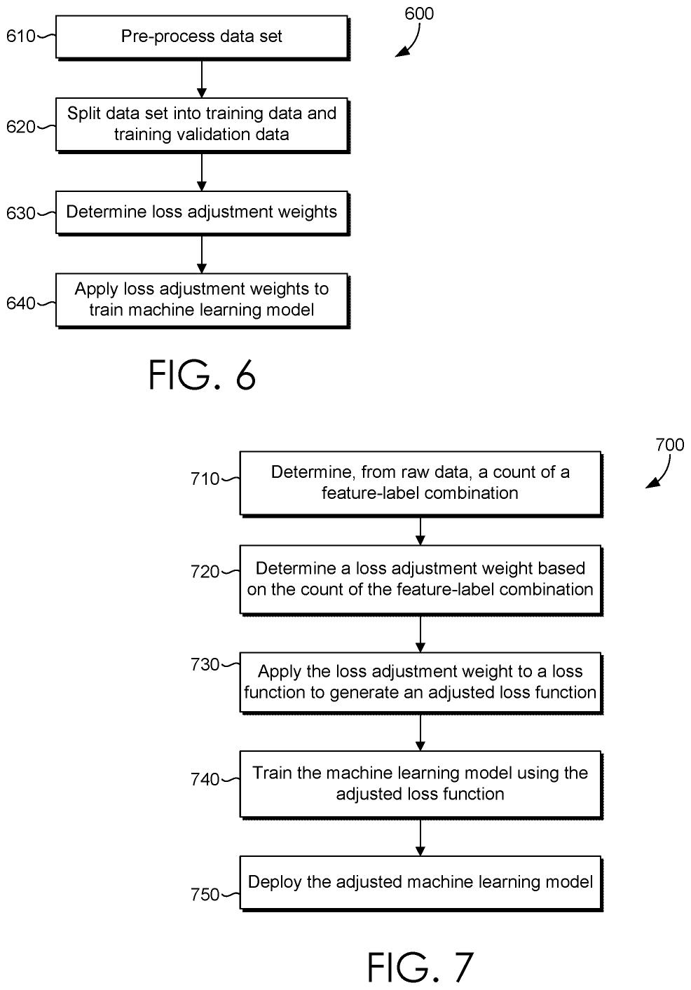

Turning now to FIG. 6, depicted is a process 600 for determining and applying loss adjustment weights (FIGS. 4-11), in accordance with embodiments of this disclosure. Indeed, process 600 (and process 700 of FIG. 7) (and/or any of the functionality described herein may be performed by processing logic that comprises hardware (for example, circuitry, dedicated logic, programmable logic, and microcode), software (for example, instructions run on a processor to perform hardware simulation), firmware, or a combination thereof. Although particular blocks described in this disclosure are referenced in a particular order or a particular quantity, it is understood that any block may occur substantially parallel with or before or after any other block. Further, more (or fewer) blocks may exist than illustrated. Such added blocks may include blocks that embody any functionality described herein. The computer-implemented method, the system (that includes at least one computing device having at least one processor and at least one computer readable storage medium), and/or the computer storage median as described herein may perform or be caused to perform the process 600 (or process 700) or any other functionality described herein.

Per block 610, particular embodiments include pre-processing a data set to generate data that can be used for machine learning purposes. In some embodiments, pre-processing data set may include generating feature vectors, for example, based on client-side data (for example, client-side data 230 of FIG. 2). As discussed above, the data initializer module 222 of FIG. 2 and/or the model initializer 442 of FIG. 4 are configured to pre-process (block 610) a data set. For example, the model initializer 442 of the bias-reducing model generating engine 440 (FIG. 4) is configured to initialize the machine learning model to be trained by the bias-reducing loss function engine 410.

Per block, 620, particular embodiments include splitting the pre-processed data set into training data 306A of FIG. 3 and into training validation data 306B of FIG. 3. In some embodiments, the training data 306A may correspond to labeled training data that is used by the model trainer 444 of FIG. 4, while the training validation data 306B may correspond to unlabeled training data that is used by the model evaluator 446 to evaluate or validate the machine learning model. However, it should be appreciated that, per block 620, the data set may be split up into any number of data sets. For example, the data set may be split up into three data sets, such that a first is used to train the machine learning model, a second data set is used to evaluate the machine learning model, and a third data set is used to validate the machine learning model. As discussed above, the bias-reducing machine learning engine may split up the training data into any number of data sets used for any suitable purpose.

Per block 630, particular embodiments include determining loss adjustment weights. The loss adjustment weights may be determined based on the training data. As discussed above, the loss function weight engine 420 of FIG. 4 may determine the loss adjustment weights. For example, the loss weight calculator 422 (of FIG. 4) of the loss function weight engine 420 may calculate the loss adjustment weights based on the counts for feature-label combinations. Per block 640, particular embodiments include applying the loss adjustment weights to train the machine learning model 310 of FIG. 3, as discussed in more detail above with respect to block 332 of FIG. 3 and the loss function weight engine 420 of FIG. 4.

Moving to FIG. 7, illustrated is a process for deploying an adjusted machine learning model, according to some embodiments of this disclosure. Per block 710, particular embodiments include determining a count of feature-label combinations, as discussed with respect to block 330 of FIG. 3. As discussed above in more detail, the sensitive feature collector 412 of FIG. 4 may receive an indication of sensitive features and corresponding groups used to train the machine learning model. Additionally, the count determining engine 414 may determine the sensitive features and/or corresponding groups, as discussed above with respect to Tables 1, 2, and 3. In some embodiments, the count of feature-label combinations may be determined based on the raw data. However, it should be understood that the count of feature-label combinations may be determined based on any additional or alternative data, such as interpreted data, modified data, pre-processed data, pruned data, culled data, and the like.

Continuing with FIG. 7, per block 720, particular embodiments include determining a loss adjustment weight based on the count of the feature-label combination. As discussed above, the loss function weight engine 420 of FIG. 4 is configured to determine the loss adjustment weight. In some embodiments, the loss adjustment weight may be computed based on any suitable statistical method, such as the chi-squared test, Fisher's exact test, and so forth. Per block 730, particular embodiments include applying the loss adjustment weight to a loss function. The loss function may be selected via the GUI 500 of FIG. 5. Per block 730, applying the loss adjustment weight to the loss function may cause the loss function to be adjusted based on the loss adjustment weight to generate an adjusted loss function. In this manner, the adjusted loss function is configured to remove bias associated with a particular group of a sensitive feature.

Per block 740, particular embodiments include training the machine learning model using the adjusted loss function generated by block 730. As discussed above, the model trainer 444 is configured to train the machine learning model based on training data (for example, labeled and/or unlabeled training data). In some embodiments, the machine learning model may be iteratively trained. For example, model parameters may be iteratively updated to reduce an error or loss calculated by the loss function (for example, the adjusted loss function). The optimizer 340 of FIG. 3 may facilitate updating the model parameters. The machine learning model may be trained until the model is evaluated against the loss threshold value and validated against a validation threshold value, so as to produce a sufficiently accurate model.

Per block 750, particular embodiments include deploying the trained machine learning model. As discussed above, the model deploying engine 448 of FIG. 4 is configured to deploy the machine learning model to any suitable abstraction layer (for example, the operating system layer, application layer, hardware layer, and so forth) of any suitable device (for example, server 106 or user device 102 of FIG. 1). In this manner, a device may run a machine learning model for which biases associated with certain sensitive features are reduced.

### Example Reduction to Practice

An illustrative example embodiment of the present disclosure that has been reduced to practice is described herein. This example embodiment comprises a bias-reducing loss function engine 410 (of FIG. 4), as described herein, applied to a machine learning model configured to predict optimal times and contexts for prompting users to complete surveys. However, it should be noted that although this example reduction-to-practice focuses specifically on a specific implementation, embodiments of the technologies described herein are more generally applicable to machine learning models trained for any other purpose using other types of training data.

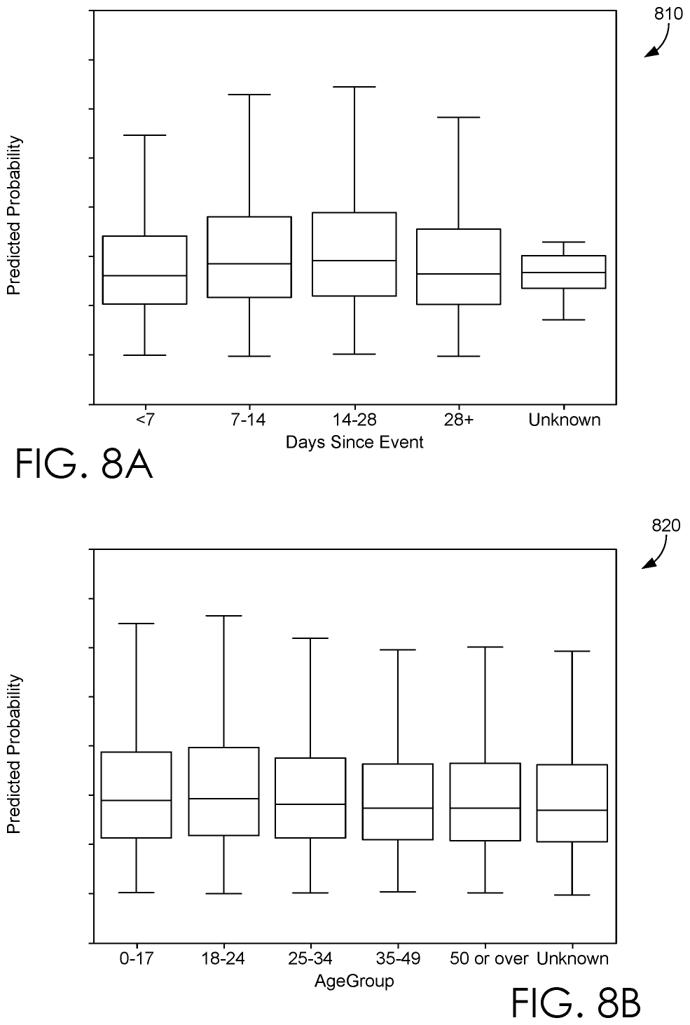

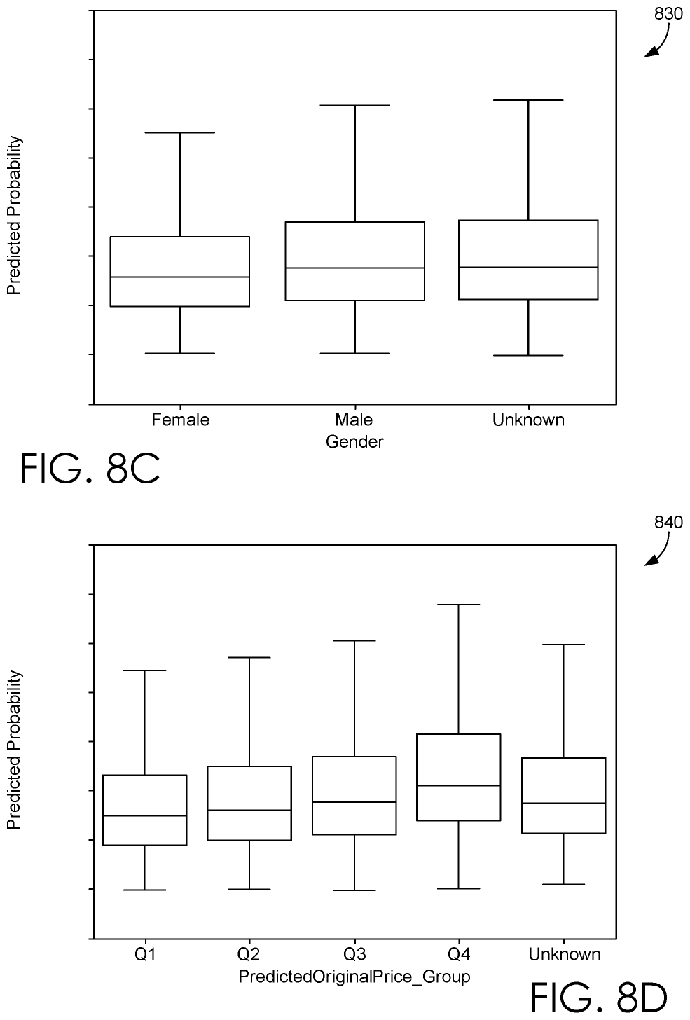

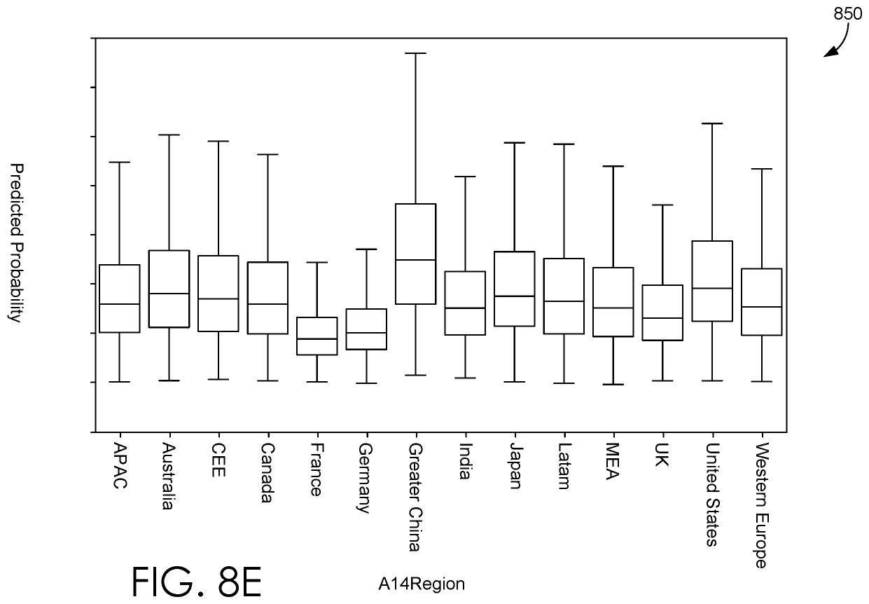

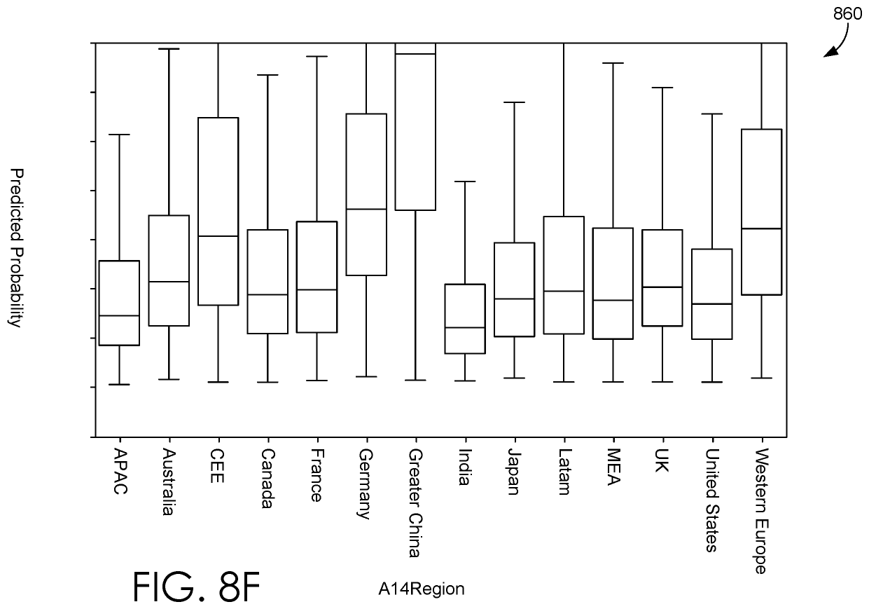

With reference to FIGS. 1-5, and with continuing reference to process 600 and 700 of FIGS. 6 and 7, respectively, this example embodiment was constructed, tested, and verified as described below. In this example, machine learning models were adjusted to improve response rate to certain questionnaires/surveys by certain groups of people. For example, it was discovered that users of older devices, users older in age, female users, users from certain regions of the world, and others, were not responding to the questionnaires/surveys at the same rate as other groups of users. This was partially due to the fact that the machine learning model was trained to prompt users to complete surveys in a manner to achieve the most responses, but the machine learning model was mainly receiving responses from certain demographics, resulting in skewed survey data that was not proportionately representative with respect to users. As such, the timing and conditions under which the surveys should be presented to these users were changed by applying loss adjustment weights to loss functions of the machine learning model. In particular, five sensitive features (discussed below with respect to FIGS. 8A-8E) were used to determine corresponding loss adjustment weights that were applied to corresponding loss functions to reduce bias associated with the sensitive feature(s).

As the first example, survey response rates appeared to differ for users operating older devices. FIG. 8A includes a box-and-whisker plot 810 illustrating the predicted probability of users based on the days since they purchased/installed certain computing resources, specifically, those having purchased/installed the computing resource before seven days, between seven and fourteen days, between fourteen and twenty-eight days, and more than twenty-eight days. In particular, FIG. 8A shows the results after the bias-reducing loss function engine 410 was implemented in the machine learning model. The box-and-whisker plot 810 of FIG. 8A illustrates response after the machine learning model was adjusted based on the loss adjustment weights being applied to the corresponding loss function. On the other hand, the table below shows the response rate ratios (comparing to 28+ group) before employing the embodiments disclosed herein.

TABLE 6
Response rate ratios before employing
bias-reducing machine learning engine

| GROUP | RESPONSE RATE |
|---|---|
| <7 | 1.8 |
| 7-14 | 1.3 |
| 14-28 | 1.4 |
| 28+ | 1.0 |

Whereas older devices had lower response rates before employing the embodiments disclosed herein, response rates were more similar across devices of different ages after loss adjustment weights were applied to the loss function used by the machine learning model. Thus, the bias-reducing loss function engine 410 was able to reduce biases associated with age of a device.

As a second example, survey response rates appeared to differ based on the age of the users. FIG. 8B includes a box-and-whisker plot 820 illustrating the predicted probability of users based on the age of the users, specifically, those being less than seventeen years old, those between eighteen and twenty-four years of age, those being between twenty-five and thirty-four years of age, those between thirty-five and fourth-nine years of age, and those over fifty years of age. The whisker plot 820 of FIG. 8B illustrates response after the machine learning model was adjusted based on the loss adjustment weights being applied to the corresponding loss function. On the other hand, the table below shows the response rate ratios (comparing to unknown group) before employing the embodiments disclosed herein.

TABLE 7
Response rate ratios before employing
bias-reducing machine learning engine

| GROUP | RESPONSE RATE |
|---|---|
| 0-17 | 3.4 |
| 18-24 | 2.9 |
| 25-34 | 1.7 |
| 35-49 | 1.9 |
| 50 or over | 2.1 |
| Unknown | 1.0 |

Whereas older users had lower response rates before employing the embodiments disclosed herein, response rates were more similar across devices of different ages after loss adjustment weights were applied to the loss function used by the machine learning model. Thus, the bias-reducing loss function engine 410 was able to reduce biases associated with age of a user.

As a third example, survey response rates appeared to differ based on the gender of the users. FIG. 8C includes a whisker plot 830 illustrating the predicted probability of user response based on the gender of the users, specifically, those identifying as female, male, or other. The whisker plot 830 of FIG. 8C illustrates predicted response after the machine learning model was adjusted based on the loss adjustment weights being applied to the corresponding loss function. On the other hand, the table below shows the response rate ratios (comparing to unknown group) before employing the embodiments disclosed herein.

TABLE 8
Response rate ratios before employing
bias-reducing machine learning engine

| GROUP | RESPONSE RATE |
|---|---|
| Female | 0.8 |
| Male | 1.9 |
| Unknown | 1.0 |

Whereas users identifying as female had lower response rates before employing the embodiments disclosed herein, response rates were more similar across users regardless of gender after loss adjustment weights were applied to the loss function used by the machine learning model. Thus, the bias-reducing loss function engine 410 was able to reduce biases associated with gender of a user.

As a fourth example, survey response rates appeared to differ based on the price of the user device. FIG. 8D includes a whisker plot 840 illustrating the predicted probability of user response based on the cost of the device ranked from those of the highest quality (Q4) to those of the lowest quality (Q1). In this example, the quality was determined based on the price or cost if the user device. The whisker plot 840 of FIG. 8D illustrates predicted response after the machine learning model was adjusted based on the loss adjustment weights being applied to the corresponding loss function. On the other hand, the table below shows the response rate ratios (comparing to unknown groups) before employing the embodiments disclosed herein.

TABLE 9
Response rate ratios before employing
bias-reducing machine learning engine

| GROUP | RESPONSE RATE |
|---|---|
| Q1 | 0.4 |
| Q2 | 0.5 |
| Q3 | 0.7 |
| Q4 | 1.0 |
| Unknown | 1.0 |

Whereas users prompted to complete surveys on lower quality devices had lower response rates before employing the embodiments disclosed herein, response rates were more similar across users regardless of the quality of their respective device after loss adjustment weights were applied to the loss function used by the machine learning model. Thus, the bias-reducing loss function engine 410 was able to reduce biases associated with quality of a user device.

As a fifth example, survey response rates appeared to differ based on the region from which the user device was identified. FIG. 8E includes a whisker plot 850 illustrating the predicted probability of user response based on the region from which the user device was located. The whisker plot 850 of FIG. 8E illustrates predicted response after the machine learning model was adjusted based on the loss adjustment weights being applied to the corresponding loss function. On the other hand, the table below shows the response rate ratios (comparing to the United States) before employing the embodiments disclosed herein.

TABLE 10
Response rate ratios before employing
bias-reducing machine learning engine

| GROUP | RESPONSE RATE |
|---|---|
| APEC | 1.2 |
| Australia | 1.5 |
| CEE | 2.7 |
| Canada | 1.8 |
| France | 1.7 |
| Germany | 2.5 |
| Greater China | 4.0 |
| India | 1.8 |
| Japan | 1.2 |
| Latam | 1.7 |
| MEA | 1.8 |
| UK | 1.5 |
| United States | 1.0 |
| Western Europe | 2.0 |

As another illustration of the response rates before employing the bias-reducing loss function engine 410, FIG. 8F includes a whisker plot 860 illustrating the user response rates based on the region from which the user device was identified before employing the bias-reducing loss function engine 410. Indeed, response rates were more similar across users regardless of their associated region after loss adjustment weights were applied to the loss function used by the machine learning model. Thus, the bias-reducing loss function engine 410 was able to reduce biases associated with geographic locations of users.

As the foregoing reduction to practice has illustrated, implementing loss adjustment weights determined in accordance with processes 600 and 700 of FIGS. 6 and 7, reduced the bias associated with training a machine learning model with certain data. In this reduction to practice, bias was reduced across different sensitive features without client-side code changes, facilitating client adoption. However, in some embodiments, client-side code changes may be implemented to enhance the machine learning training.

### Other Embodiments

In some embodiments, a computerized system, such as the system described in any of the embodiments above, comprises at least one computer processor and computer memory storing computer-useable instructions that, when executed by the at least one computer processor, cause the at least one computer processor to perform operations. The operations comprise determining, at a bias reducing machine learning engine and from training data, a count of a feature-label combination relating a sensitive feature to a label. The operations also comprise determining a loss adjustment weight based on the count of the feature-label combination, and applying the loss adjustment weight to a loss function to generate an adjusted loss function. The operations further comprise training a machine learning model using the adjusted loss function to generate an adjusted machine learning model. The operations further comprise causing deployment of the adjusted machine learning model for use in a computing application. Advantageously, these and other embodiments, as described herein, provide technology to improve machine learning systems by removing or reducing biases associated with some features by performing a loss adjustment operation that utilizes a modified or customized loss function during the training of the machine learning model. Further, these embodiments remove biases in machine learning applications without requiring computer code for addressing the biases to run on the computing system where the model is deployed and/or running, such as a computer program operating on a client computer, and thus address the bias problem in a computationally efficient manner. Further still, these embodiments can be personalized or tailored for certain types of data, such as sensitive data. Further still, these embodiments can provide for the selection of particular sensitive features. Accordingly, these embodiments are not only more accurate, but are more easily scaled compared to existing computationally intensive approaches.

In any combination of the above embodiments of the system, the operations may further comprise converting the training data into a table or a vector configured to associate a group of the sensitive feature to a corresponding label, and wherein the loss adjustment weight is determined based on a statistical analysis of the table or vector.

In any combination of the above embodiments of the system, the statistical analysis comprises performing a chi-squared test or Fisher's exact test on the converted training data.

In any combination of the above embodiments of the system, the count of the feature-label combination is determined based on a frequency of the sensitive feature relative to the label, and wherein training the machine learning model using the adjusted loss function reduces a bias attributed to the sensitive feature.

In any combination of the above embodiments of the system, the sensitive feature comprises a gender feature, a race feature, an age feature, a socioeconomic feature, a geographical location feature, or a health feature.

In any combination of the above embodiments of the system, the operations may further comprise determining the loss function based on the machine learning model, wherein the loss adjustment weight is determined based on the loss function and the count of the feature-label combination.

In any combination of the above embodiments of the system, the sensitive feature is specified in response to a user input to JSON file of a user interface.

In any combination of the above embodiments of the system, the adjusted machine learning model is deployed to an abstraction layer of a client device or a server device, wherein the abstraction layer comprises at least one of an operating system layer, an application layer, or a hardware layer.

In any combination of the above embodiments of the system, the operations comprise causing presentation of a graphical user interface comprising (i) a first control configured to receive a first user input indicative of the sensitive feature and (ii) a second control configured to receive a second user input indicative of the label.

In any combination of the above embodiments of the system, the operations are performed without receipt of client-side code.

In some embodiments, one or more computer storage media having computer-executable instructions embodied thereon that, when executed by a computing system having a processor and memory, cause operations to be performed. The operations comprise determining, at a bias reducing machine learning engine, a count of a feature-label combination relating a sensitive feature to a label. The operations also comprise determining a loss adjustment weight based on the count of the feature-label combination, and applying the loss adjustment weight to a loss function associated with a machine learning model to generate an adjusted loss function. The operations further comprise training the machine learning model using the adjusted loss function to generate an adjusted machine learning model. The operations further comprise deploying the adjusted machine learning model to an operating system layer of a client device or a server device and for use in a software application of the client device or of the server device. Advantageously, these and other embodiments, as described herein, provide technology to improve machine learning systems by removing or reducing biases associated with some features by performing a loss adjustment operation that utilizes a modified or customized loss function during the training of the machine learning model. Further, these embodiments remove biases in machine learning applications without requiring computer code for addressing the biases to run on the computing system where the model is deployed and/or running, such as a computer program operating on a client computer, and thus address the bias problem in a computationally efficient manner. Further still, these embodiments can be personalized or tailored for certain types of data, such as sensitive data. Further still, these embodiments can provide for the selection of particular sensitive features. Accordingly, these embodiments are not only more accurate, but are more easily scaled compared to existing computationally intensive approaches.

In any combination of the above embodiments, the instructions may further cause the processor to convert the training data into a table or vector configured to associate a group of the sensitive feature to a corresponding label, and wherein the loss adjustment weight is determined based on a statistical analysis of the table or vector, the statistical analysis comprising a chi-squared test or Fisher's exact test.

In any combination of the above embodiments, the count of the feature-label combination is determined based on a frequency of the sensitive feature relative to the label, and wherein training the machine learning model using the adjusted loss function reduces a bias attributed to the sensitive feature.

In any combination of the above embodiments, the count of the feature-label combination is determined based on a frequency of the sensitive feature relative to the label, wherein the sensitive feature is engineered based on a numerical transformation, a category encoder, a clustering technique, a group aggregation value, or principal component analysis.

In any combination of the above embodiments, the instructions may further cause the processor to determining the loss function based on the machine learning model, wherein the loss adjustment weight is determined based on the loss function and the count of the feature-label combination.

In some embodiments, a computer-implemented method is provided. The method comprises accessing training data and training a machine learning model based on the training data. The method further comprises evaluating the machine learning model. The method, including evaluating the machine learning model, also comprises determining a count of a feature-label combination relating a sensitive feature to a label. The method, including evaluating the machine learning model, also comprises determining a loss adjustment weight based on the count of the feature-label combination, and applying the loss adjustment weight to a loss function of the machine learning model to generate an adjusted loss function configured to reduce an error attributed to the sensitive feature. The method, including evaluating the machine learning model, further comprises re-training a machine learning model using the adjusted loss function to generate an adjusted machine learning model. The method further comprises deploying the adjusted machine learning model. Advantageously, these and other embodiments, as described herein, provide technology to improve machine learning systems by removing or reducing biases associated with some features by performing a loss adjustment operation that utilizes a modified or customized loss function during the training of the machine learning model. Further, these embodiments remove biases in machine learning applications without requiring computer code for addressing the biases to run on the computing system where the model is deployed and/or running, such as a computer program operating on a client computer, and thus address the bias problem in a computationally efficient manner. Further still, these embodiments can be personalized or tailored for certain types of data, such as sensitive data. Further still, these embodiments can provide for the selection of particular sensitive features. Accordingly, these embodiments are not only more accurate, but are more easily scaled compared to existing computationally intensive approaches.

In any combination of the above embodiments, the machine learning model may be re-trained until an adjusted loss output by the adjusted loss function satisfies a loss threshold.

In any combination of the above embodiments, the count of the feature-label combination may be determined based on a frequency of the sensitive feature relative to the label, and wherein training the machine learning model using the adjusted loss function reduces a bias attributed to the sensitive feature.

In any combination of the above embodiments, the count of the feature-label combination may be determined based on a frequency of the sensitive feature relative to the label, wherein the sensitive feature is engineered based on a numerical transformation, a category encoder, a clustering technique, a group aggregation value, or principal component analysis.

In any combination of the above embodiments, the adjusted machine learning model may be deployed to an abstraction layer of a client device or a server device, wherein the abstraction layer comprises at least one of an operating system layer, an application layer, or a hardware layer.

### Overview of Exemplary Operating Environment

Having described various embodiments of the disclosure, an exemplary computing environment suitable for implementing embodiments of the disclosure is now described. With reference to FIG. 9, an exemplary computing device is provided and referred to generally as computing device 900. The computing device 900 is but one example of a suitable computing environment and is not intended to suggest any limitation as to the scope of use or functionality of the disclosure. Neither should the computing device 900 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the disclosure may be practiced in a variety of system configurations, including handheld devices, consumer electronics, general-purpose computers, more specialty computing devices, or similar computing or processing devices. Embodiments of the disclosure may also be practiced in distributed computing environments where tasks are performed by remote-processing devices that are linked through a communications network. In a distributed computing environment, program modules may be located in both local and remote computer storage media including memory storage devices.

With reference to FIG. 9, computing device 900 includes a bus 910 that directly or indirectly couples the following devices: memory 912, one or more processors 914, one or more presentation components 916, one or more input/output (I/O) ports 918, one or more I/O components 920, and an illustrative power supply 922. Bus 910 represents what may be one or more busses (such as an address bus, data bus, or combination thereof). Although the various blocks of FIG. 9 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 9 is merely illustrative of an exemplary computing device that can be used in connection with one or more embodiments of the present disclosure. Distinction is not made between such categories as “workstation,” “server,” “laptop,” “handheld device,” or the like, as all are contemplated within the scope of FIG. 9 and with reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage median and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 912 includes computer storage media in the form of volatile and/or nonvolatile memory. The memory may be removable, non-removable, or a combination thereof. Exemplary hardware devices include solid-state memory, hard drives, optical-disc drives, and similar physical storage media. Computing device 900 includes one or more processors 914 that read data from various entities such as memory 912 or I/O components 920. Presentation component(s) 916 presents data indications to a user or other device. Exemplary presentation components include a display device, speaker, printing component, vibrating component, and the like.

The I/O ports 918 allow computing device 900 to be logically coupled to other devices, including I/O components 920, some of which may be built in. Illustrative components include, by way of example and not limitation, a microphone, joystick, game pad, satellite dish, scanner, printer, wireless device, and other I/O components. The I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, red-green-blue (RGB) camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

Some embodiments of computing device 900 may include one or more radio(s) 924 (or similar wireless communication components). The radio 924 transmits and receives radio or wireless communications. The computing device 900 may be a wireless terminal adapted to receive communications and media over various wireless networks. Computing device 900 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (for example, mobile hotspot) that provides access to a wireless communications network, such as a wireless local-area network (WLAN) connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

### Example Distributed Computing System Environment

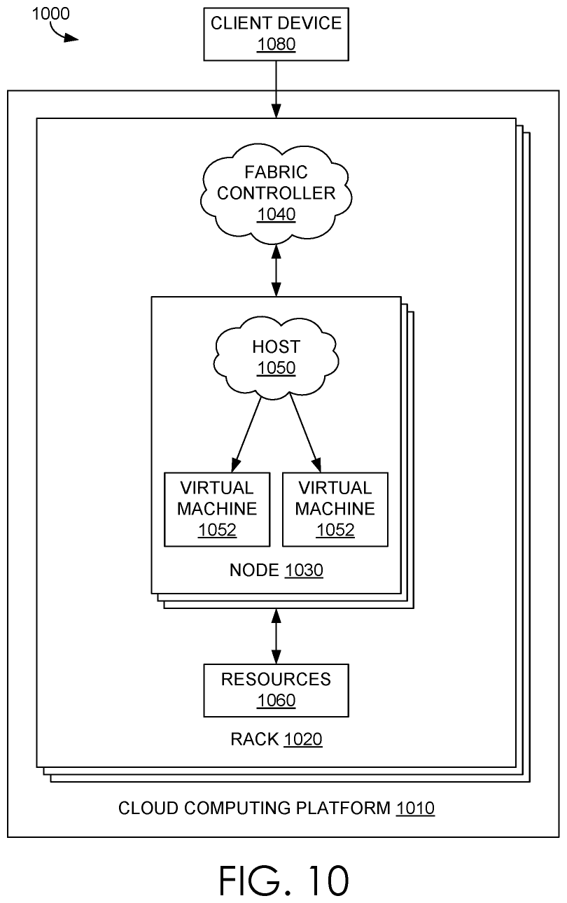

Referring now to FIG. 10, FIG. 10 illustrates an example distributed computing environment 1000 in which implementations of the present disclosure may be employed. In particular, FIG. 10 shows a high level architecture of an example cloud computing platform 1010 that can host a technical solution environment, or a portion thereof (for example, a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 1000 that includes cloud computing platform 1010, rack 1020, and node 1030 (for example, computing devices, processing units, or blades) in rack 1020. The technical solution environment can be implemented with cloud computing platform 1010 that runs cloud services across different data centers and geographic regions. Cloud computing platform 1010 can implement fabric controller 1040 component for provisioning and managing resource allocation, deployment, upgrade, and management of cloud services. Typically, cloud computing platform 1010 acts to store data or run service applications in a distributed manner. Cloud computing infrastructure 1010 in a data center can be configured to host and support operation of endpoints of a particular service application. Cloud computing infrastructure 1010 may be a public cloud, a private cloud, or a dedicated cloud.

Node 1030 can be provisioned with host 1050 (for example, operating system or runtime environment) running a defined software stack on node 1030. Node 1030 can also be configured to perform specialized functionality (for example, compute nodes or storage nodes) within cloud computing platform 1010. Node 1030 is allocated to run one or more portions of a service application of a tenant. A tenant can refer to a user, such as a customer, utilizing resources of cloud computing platform 1010. Service application components of cloud computing platform 1010 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 1030, nodes 1030 may be partitioned into virtual machines (for example, virtual machine 1052 and virtual machine 1054). Physical machines can also concurrently run separate service applications. The virtual machines or physical machines can be configured as individualized computing environments that are supported by resources 1060 (for example, hardware resources and software resources) in cloud computing platform 1010. It is contemplated that resources can be configured for specific service applications. Further, each service application may be divided into functional portions such that each functional portion is able to run on a separate virtual machine. In cloud computing platform 1010, multiple servers may be used to run service applications and perform data storage operations in a cluster. In particular, the servers may perform data operations independently but exposed as a single device referred to as a cluster. Each server in the cluster can be implemented as a node.

Client device 1080 may be linked to a service application in cloud computing platform 1010. Client device 1080 may be any type of computing device, such as user device 102a described with reference to FIG. 1, and the client device 1080 can be configured to issue commands to cloud computing platform 1010. In embodiments, client device 1080 may communicate with service applications through a virtual Internet Protocol (IP) and load balancer or other means that direct communication requests to designated endpoints in cloud computing platform 1010. The components of cloud computing platform 1010 may communicate with each other over a network (not shown), which may include, without limitation, one or more local area networks (LANs) and/or wide area networks (WANs).

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

### Additional Structural and Functional Features of Embodiments of the Technical Solutions

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system, the computerized system comprising:
at least one computer processor; and
computer memory storing computer-useable instructions that, when used by the at least one computer processor, cause the at least one computer processor to perform operations comprising:
determining, at a bias reducing machine learning engine and from training data, a count of a feature-label combination relating a sensitive feature to a label;
determining a loss adjustment weight based on the count of the feature-label combination;
applying the loss adjustment weight to a loss function to generate an adjusted loss function;
training a machine learning model using the adjusted loss function to generate an adjusted machine learning model;
deploying the adjusted machine learning model for use in a computing application.

2. The computerized system of claim 1, the operations further comprising converting the training data into a table or a vector configured to associate a group of the sensitive feature to a corresponding label, and wherein the loss adjustment weight is determined based on a statistical analysis of the table or vector.

3. The computerized system of claim 2, wherein the statistical analysis comprises performing a chi-squared test or Fisher's exact test on the converted training data.

4. The computerized system of claim 1, wherein the count of the feature-label combination is determined based on a frequency of the sensitive feature relative to the label, and wherein training the machine learning model using the adjusted loss function reduces a bias attributed to the sensitive feature.

5. The computerized system of claim 1, wherein the sensitive feature comprises a gender feature, a race feature, an age feature, a socioeconomic feature, a geographical location feature, or a health feature.

6. The computerized system of claim 1, wherein the operations comprise:
determining the loss function based on the machine learning model, wherein the loss adjustment weight is determined based on the loss function and the count of the feature-label combination.

7. The computerized system of claim 1, wherein the sensitive feature is specified in response to a user input to JSON file of a user interface.

8. The computerized system of claim 1, wherein the adjusted machine learning model is deployed to an abstraction layer of a client device or a server device, wherein the abstraction layer comprises at least one of an operating system layer, an application layer, or a hardware layer.

9. The computerized system of claim 1, wherein the operations comprise causing presentation of a graphical user interface comprising (i) a first control configured to receive a first user input indicative of the sensitive feature and (ii) a second control configured to receive a second user input indicative of the label.

10. The computerized system of claim 1, wherein the operations are performed without receipt of client-side code.

11. One or more computer-storage media having computer-executable instructions embodied thereon that, when executed by a computing system having a processor and memory, cause the processor to:
determine, at a bias reducing machine learning engine, a count of a feature-label combination relating a sensitive feature to a label;
determine a loss adjustment weight based on the count of the feature-label combination;
apply the loss adjustment weight to a loss function associated with a machine learning model to generate an adjusted loss function;
train the machine learning model using the adjusted loss function to generate an adjusted machine learning model;
deploy the adjusted machine learning model to an operating system layer of a client device or a server device and for use in a software application of the client device or of the server device.

12. The computer-storage media of claim 11, wherein the instructions further cause the processor to convert the training data into a table or vector configured to associate a group of the sensitive feature to a corresponding label, and wherein the loss adjustment weight is determined based on a statistical analysis of the table or vector, the statistical analysis comprising a chi-squared test or Fisher's exact test.

13. The computer-storage media of claim 11, wherein the count of the feature-label combination is determined based on a frequency of the sensitive feature relative to the label, and wherein training the machine learning model using the adjusted loss function reduces a bias attributed to the sensitive feature.

14. The computer-storage media of claim 11, wherein the count of the feature-label combination is determined based on a frequency of the sensitive feature relative to the label, wherein the sensitive feature is engineered based on a numerical transformation, a category encoder, a clustering technique, a group aggregation value, or principal component analysis.

15. The computer-storage media of claim 11, wherein the instructions further cause the processor to determining the loss function based on the machine learning model, wherein the loss adjustment weight is determined based on the loss function and the count of the feature-label combination.

16. A computer-implemented method, comprising:
accessing training data;
training a machine learning model based on the training data;
evaluating the machine learning model, wherein evaluating the machine learning model comprises:
determining a count of a feature-label combination relating a sensitive feature to a label;
determining a loss adjustment weight based on the count of the feature-label combination;
applying the loss adjustment weight to a loss function of the machine learning model to generate an adjusted loss function configured to reduce an error attributed to the sensitive feature;
re-training a machine learning model using the adjusted loss function to generate an adjusted machine learning model; and
deploying the adjusted machine learning model.

17. The computer-implemented method of claim 16, wherein the machine learning model is re-trained until an adjusted loss output by the adjusted loss function satisfies a loss threshold.

18. The computer-implemented method of claim 16, wherein the count of the feature-label combination is determined based on a frequency of the sensitive feature relative to the label, and wherein training the machine learning model using the adjusted loss function reduces a bias attributed to the sensitive feature.

19. The computer-implemented method of claim 16, wherein the count of the feature-label combination is determined based on a frequency of the sensitive feature relative to the label, wherein the sensitive feature is engineered based on a numerical transformation, a category encoder, a clustering technique, a group aggregation value, or principal component analysis.

20. The computer-implemented method of claim 16, wherein the adjusted machine learning model is deployed to an abstraction layer of a client device or a server device, wherein the abstraction layer comprises at least one of an operating system layer, an application layer, or a hardware layer.
